(19) United States
(12) Patent Application Publication
(10) Pub. No.: US 2026/0285101 A1
(43) Pub. Date: Sep. 24, 2026

(54) VALVE STEM COVER

(71) Applicant: Deere & Company, Moline, IL (US)

(72) Inventors: Shane M. Boden, Vinton, IA (US); Gary S. Keys, II, Cedar Falls, IA (US); Mason K. Drees, West Des Moines, IA (US)

(21) Appl. No.: 19/087,860

(22) Filed: Mar. 24, 2025

(51) Int. Cl. B60C 29/06

(52) U.S. Cl. CPC B60C 29/066

(57) ABSTRACT

A valve stem cover includes a base configured to removably attach to the valve stem protruding from a wheel, the base includes an opening to receive the valve stem, and a cap removably attached to the base, the cap and the base forming an enclosure configured to receive the valve stem and a tire pressure sensor connected to the valve stem.

### FIELD OF THE DISCLOSURE

The present disclosure relates to a valve stem cover.

### BACKGROUND

Work vehicles include wheels with tires. Each tire has a valve stem for inflating and deflating the tire. Each valve stem can include a tire pressure sensor.

### SUMMARY

According to an aspect of the present disclosure, a valve stem cover includes a base configured to removably attach to the valve stem protruding from a wheel, the base includes an opening to receive the valve stem, and a cap removably attached to the base, the cap and the base forming an enclosure configured to receive the valve stem and a tire pressure sensor connected to the valve stem.

According to an aspect of the present disclosure, the valve stem further includes a fastener configured to removably attach the base to the valve stem, the fastener configured to engage threads of the valve stem.

According to an aspect of the present disclosure, the base includes an axial protrusion extending toward the wheel to resist rotation of the base.

According to an aspect of the present disclosure, the base includes an internal bolt head pattern configured to fit over a nut positioned on the valve stem below the base to resist rotation of the base.

According to an aspect of the present disclosure, the base includes two or more corresponding flat surfaces configured to receive a wrench.

According to an aspect of the present disclosure, the base includes an external bolt head pattern configured to receive a wrench.

According to an aspect of the present disclosure, the cap removably fastens to the base via interacting screw threads.

According to an aspect of the present disclosure, screw threads on the cap engage with screw threads on the base to removably fasten the cap to the base.

According to an aspect of the present disclosure, buttress threads on the cap engage with buttress threads on the base to removably fasten the cap to the base.

According to an aspect of the present disclosure, the cap removably attaches to the base via a friction fit.

According to an aspect of the present disclosure, the cap removably attaches to the base via flexible ribs.

According to an aspect of the present disclosure, the base includes one or more extensions, the cap includes one or more extensions, and one or more fasteners connect the one or more extensions of the cap to the one or more extensions of base.

According to an aspect of the present disclosure, the base includes threads around the opening to engage threads of the valve stem.

According to an aspect of the present disclosure, a seal is positioned between the base and the cap forming a sealed enclosure when the cap is attached to the base.

According to an aspect of the present disclosure, a valve stem cover includes a base configured to removably attach to the valve stem protruding from a wheel, the base including an opening to receive the valve stem, the base including an internal bolt head pattern configured to fit over a nut positioned on the valve stem below the base to resist rotation of the base, the base including an external bolt head pattern configured to receive a wrench, a cap removably attached to the base, the cap and the base forming an enclosure configured to receive the valve stem and a tire pressure sensor connected to the valve stem, the cap removably fastened to the base via screw threads, and a fastener configured to removably attach the base to the valve stem, the fastener configured to engage threads of the valve stem.

The above and other features will become apparent from the following detailed description and accompanying drawings.

### BRIEF DESCRIPTION OF THE DRAWINGS

The detailed description refers to the accompanying figures.

FIG. 1 is a perspective view of a work vehicle including a valve stem cover, according to an implementation.

FIGS. 2-4 illustrate a valve stem cover, according to an implementation; FIG. 2 is a perspective view of the valve stem cover; FIG. 3 is a perspective view of the valve stem cover; and FIG. 4 is a cross-sectional view of the valve stem cover.

FIGS. 5-7 illustrate a valve stem cover, according to an implementation; FIG. 5 is a perspective view of the valve stem cover; FIG. 6 is a perspective view of the valve stem cover; and FIG. 7 is a cross-sectional view of the valve stem cover.

FIGS. 8-10 illustrate a valve stem cover 120, according to an implementation; FIG. 8 is a perspective view of the valve stem cover; FIG. 9 is a perspective view of the valve stem cover; and FIG. 10 is a cross-sectional view of the valve stem cover.

FIGS. 11-13 illustrate a valve stem cover, according to an implementation; FIG. 11 is a perspective view of the valve stem cover; FIG. 12 is a perspective view of the valve stem cover; and FIG. 13 is a cross-sectional view of the valve stem cover.

FIGS. 14-16 illustrate a valve stem cover, according to an implementation; FIG. 14 is a perspective view of the valve stem cover; FIG. 15 is a perspective view of the valve stem cover; and FIG. 16 is a cross-sectional view of the valve stem cover.

FIGS. 17-19 illustrate a valve stem cover, according to an implementation; FIG. 17 is a perspective view of the valve stem cover; FIG. 18 is a perspective view of the valve stem cover; and FIG. 19 is a cross-sectional view of the valve stem cover.

FIGS. 20-22 illustrate a valve stem cover, according to an implementation; FIG. 20 is a perspective view of the valve stem cover; FIG. 21 is a perspective view of the valve stem cover; and FIG. 22 is a cross-sectional view of the valve stem cover.

FIGS. 23-25 illustrate a valve stem cover, according to an implementation; FIG. 23 is a perspective view of the valve stem cover; FIG. 24 is a perspective view of the valve stem cover; and FIG. 25 is a cross-sectional view of the valve stem cover.

FIGS. 26-28 illustrate a valve stem cover, according to an implementation; FIG. 26 is a perspective view of the valve stem cover; FIG. 27 is a perspective view of the valve stem cover; and FIG. 28 is a cross-sectional view of the valve stem cover.

FIGS. 29-32 illustrate a valve stem cover, according to an implementation; FIG. 29 is a top perspective view of a base for the valve stem cover; FIG. 30 is a bottom perspective view of a base for the valve stem cover; FIG. 31 is a top perspective view of cap for the valve stem cover; and FIG. 32 is a perspective view of a cap for the valve stem cover.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

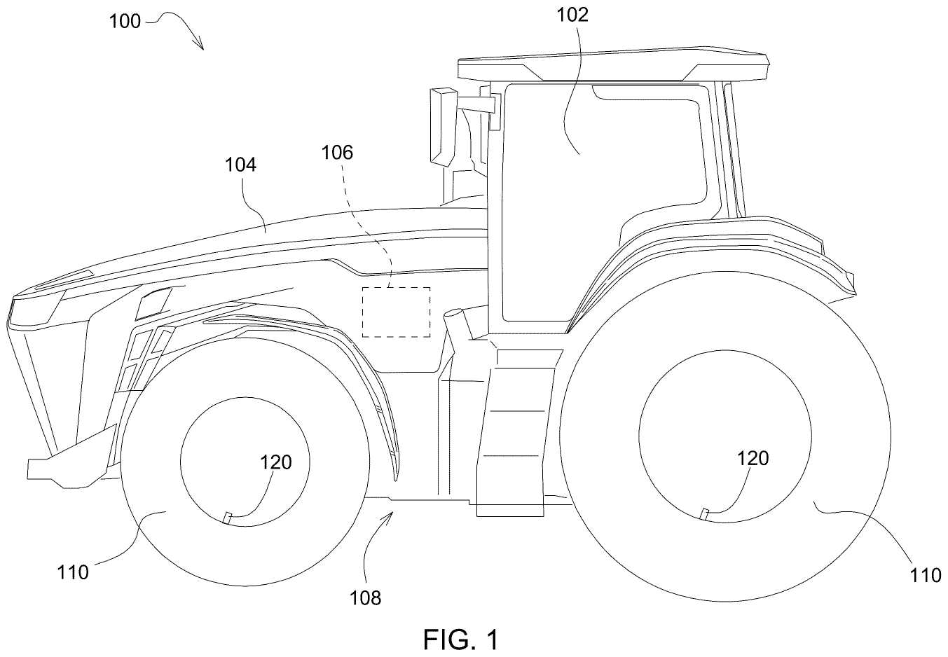

With reference to FIG. 1, a work vehicle 100, for example an agricultural tractor, can include an operator station or cab 102, a hood 104, one or more power sources 106 (e.g., an internal combustion engine, a hybrid engine, a battery, an electric machine, etc.), a rigid or articulated frame or chassis 108, and wheels 110. The work vehicle 100 can include a valve stem cover 120 for each of the wheels 110. The valve stem cover 120 used with a variety of different wheels 110.

With reference to all the FIGURES, a valve stem cover 120 includes a base 130 and a cap 150. The base 130 can be a single component or multiple components. The base 130 can include a portion configured to receive the valve stem 112 and a portion extending in a direction along the axis of the valve stem 112 away from the wheel 110. The base 130 can include an opening 132 to receive the valve stem 112. The opening 132 is positioned in the portion of the base 130 configured to receive the valve stem 112. The opening 132 can be sized to slide over the valve stem 112, or the base 130 can include internal screw threads around the opening 132 to engage the screw threads 116 of the valve stem 112.

The base 130 can removably attach to the valve stem 112 protruding from the wheel 110 via a fastener 134, which engages the screw threads 116 of the valve stem 122. For example, a nut 134 engages the screw threads 116 of the valve stem 112 to removably attach the base 130 to the valve stem 112. When the base 130 is attached to the valve stem 112, the base 130 can contact the wheel 110 in some implementations, or the base 130 can remain spaced apart from the wheel 110 in other implementations.

The base 130 can include an axial protrusion 136 extending away from the base 130 towards the wheel 110 to resist rotation of the base 130. The base 130 can include a plurality of axial protrusions 136 extending away from the base 130 towards the wheel 110 to resist rotation of the base 130. The base 130 can include an internal bolt head pattern 138 configured to fit over a nut 118 positioned on the valve stem 112 below the base 130 to resist rotation of the base 130. The base 130 can include two or more corresponding flat surfaces 140 configured to receive a wrench or other tool for attaching the base 130 to the valve stem 112 and for removing the base 130 from the valve stem 112. For example, the base 130 can include an external bolt head pattern 140 configured to receive a wrench or other tool.

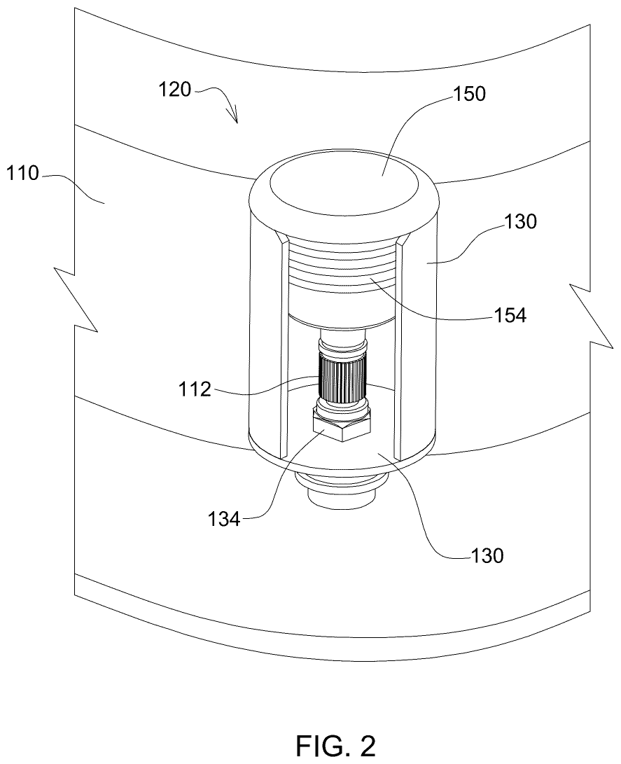

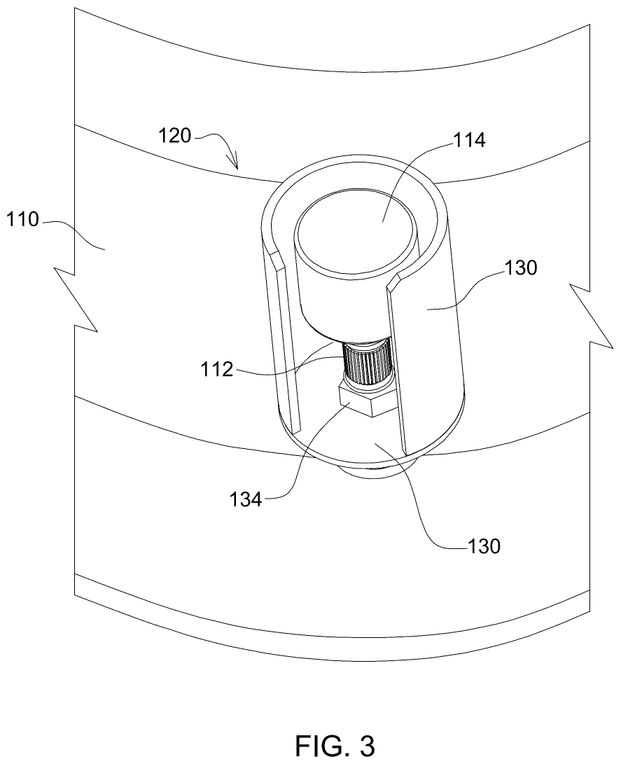

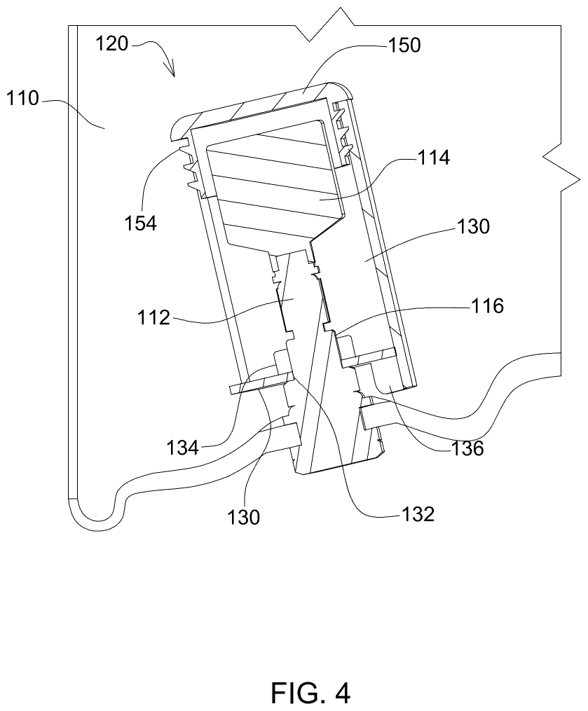

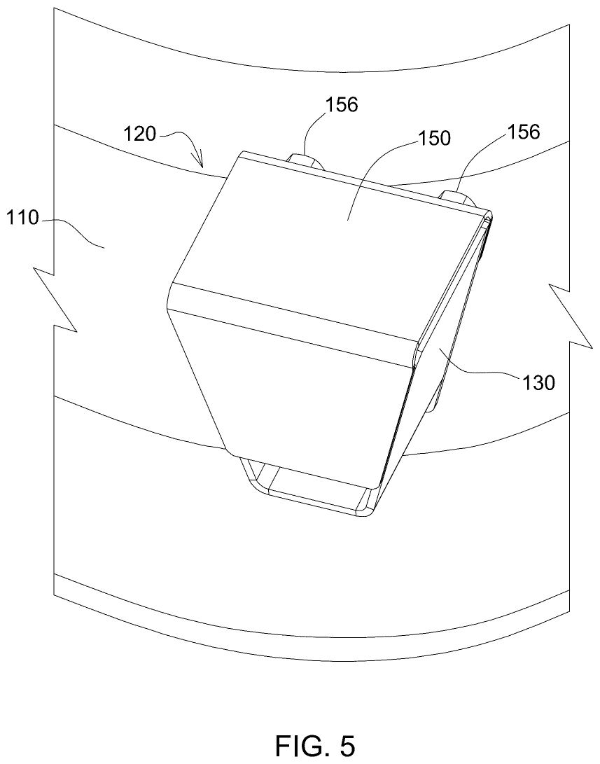

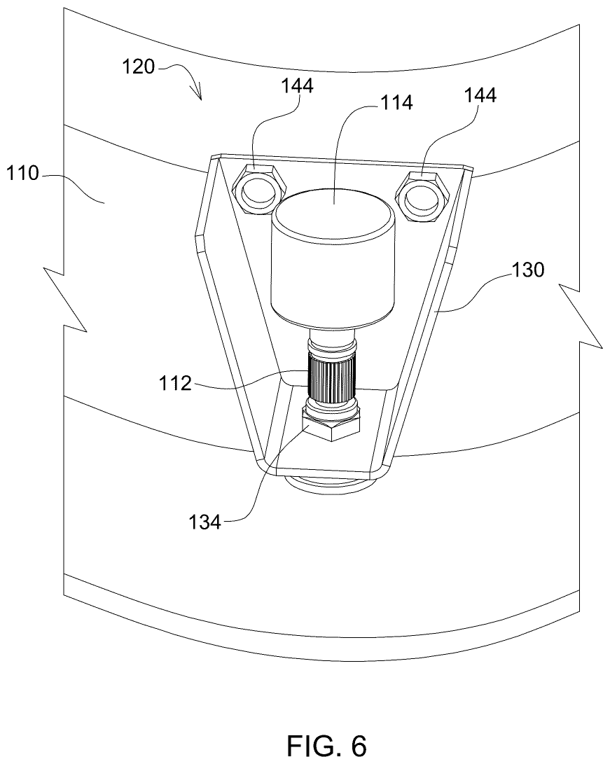

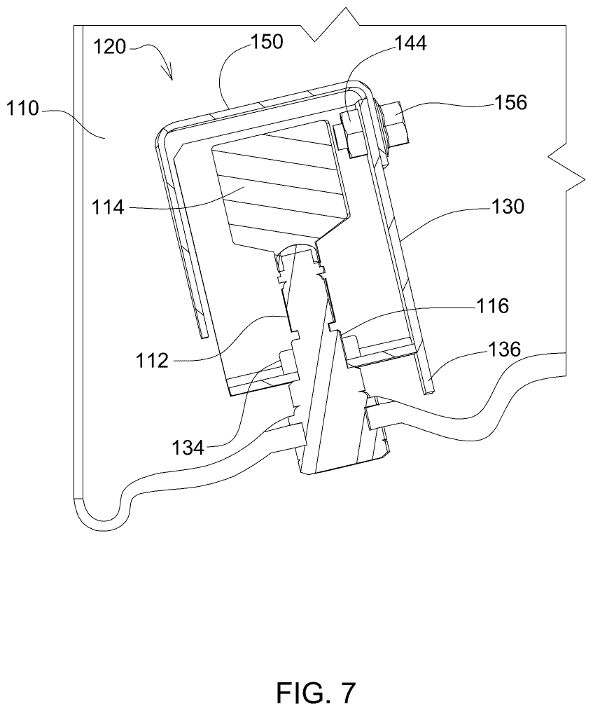

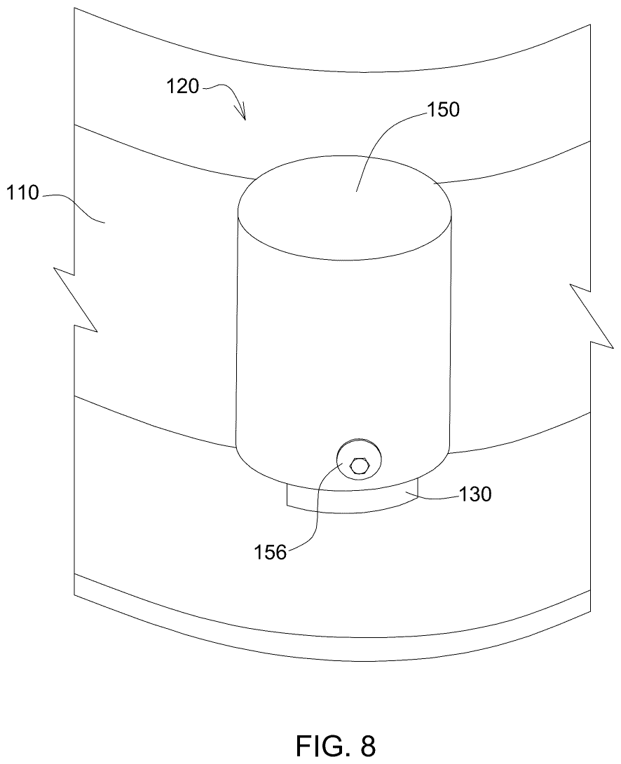

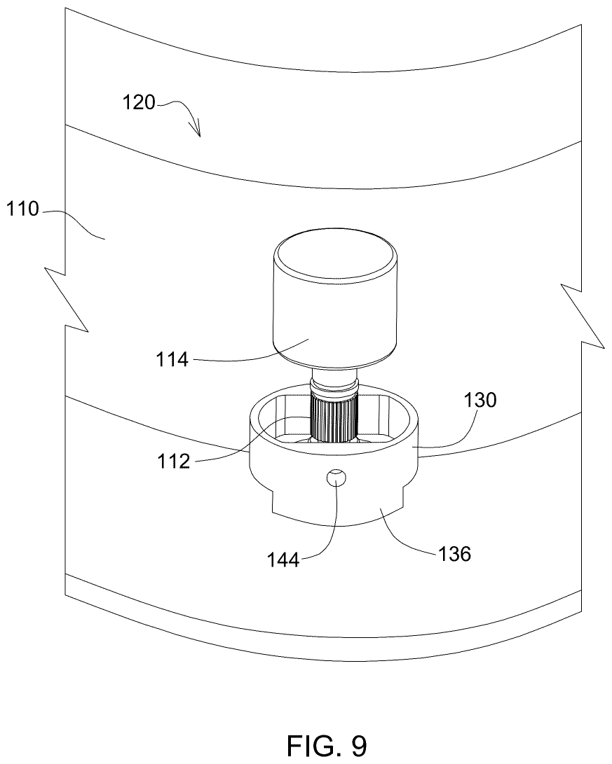

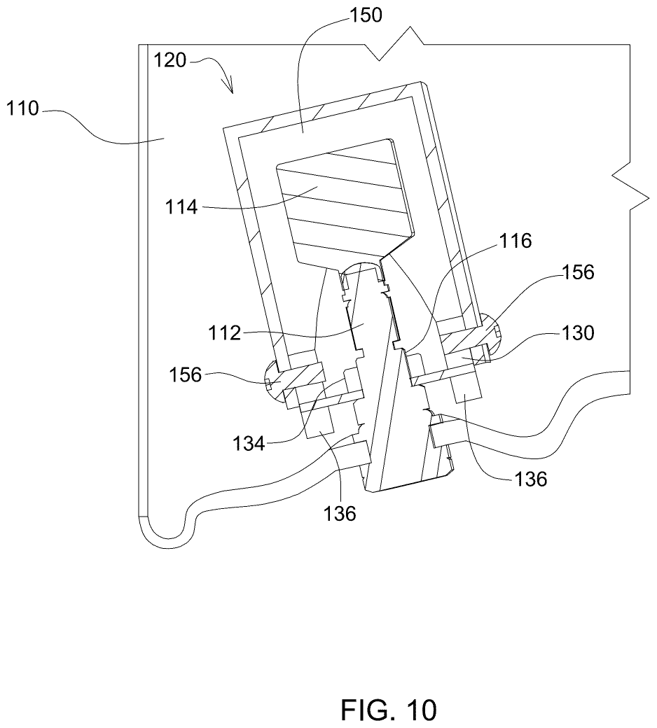

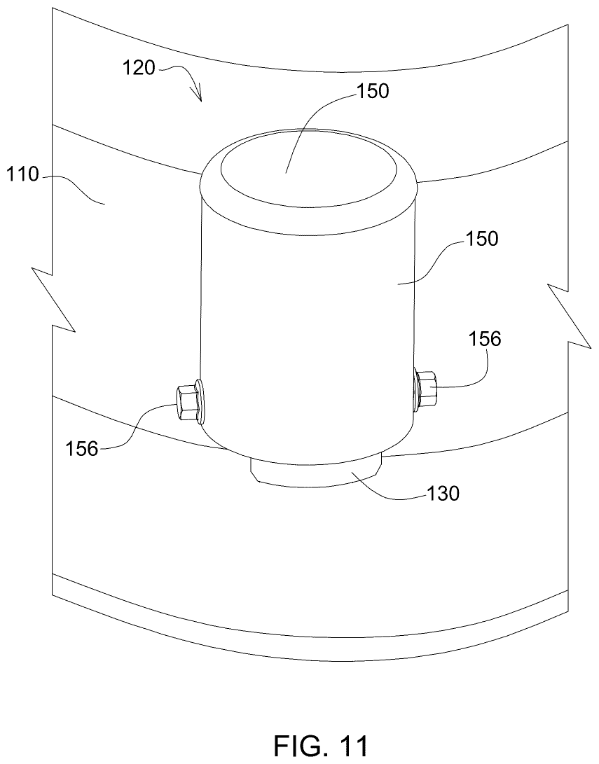

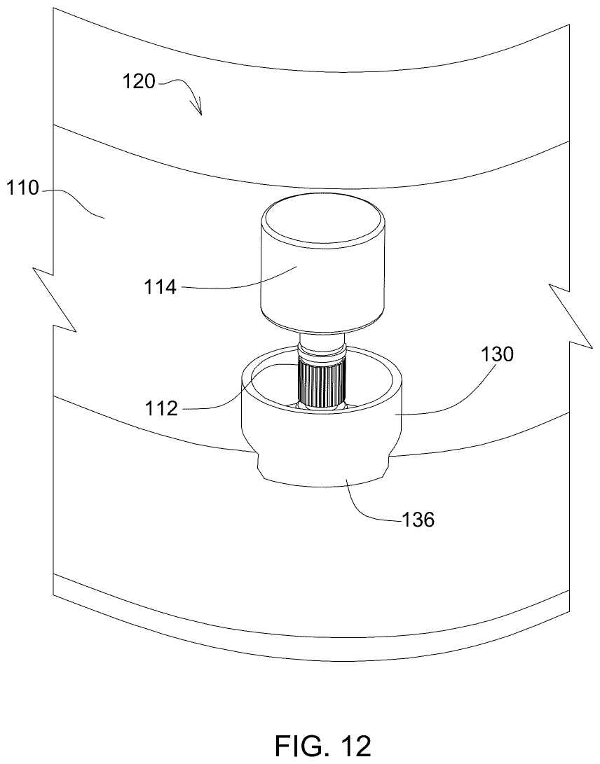

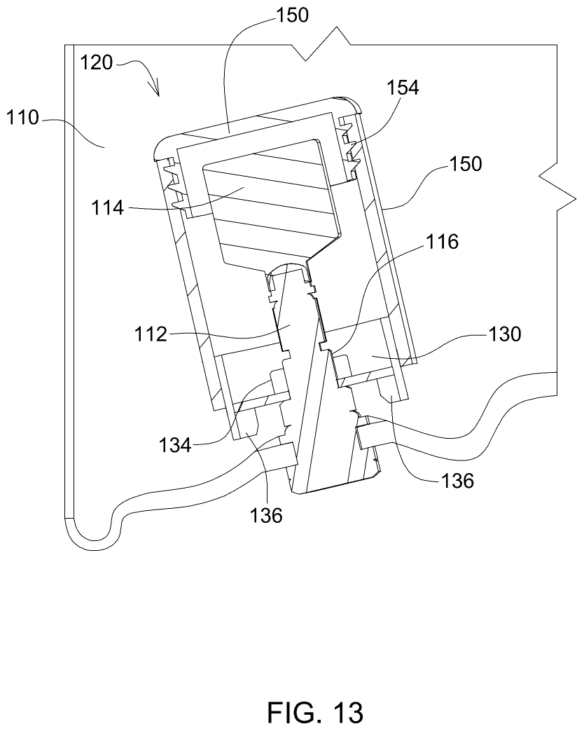

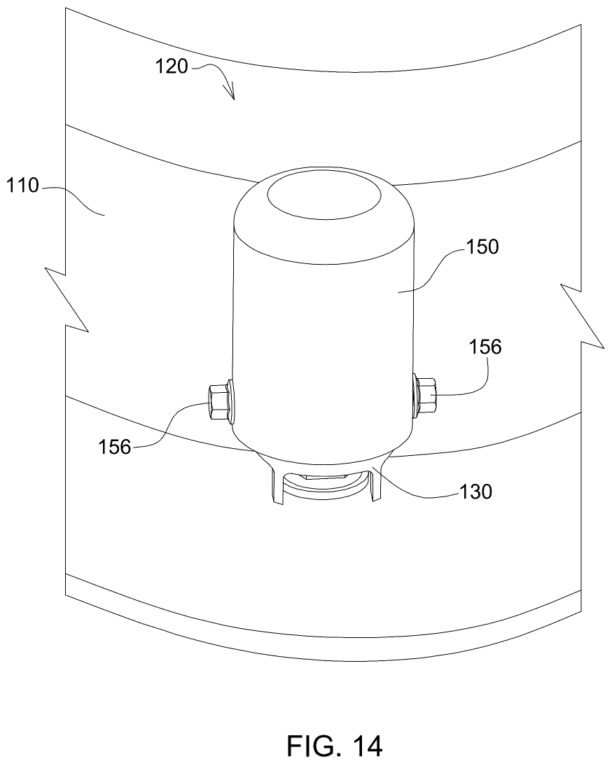

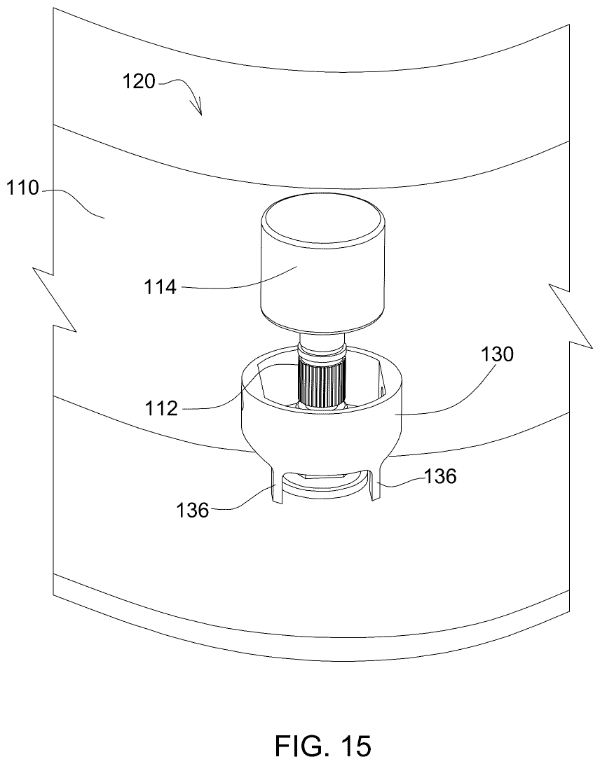

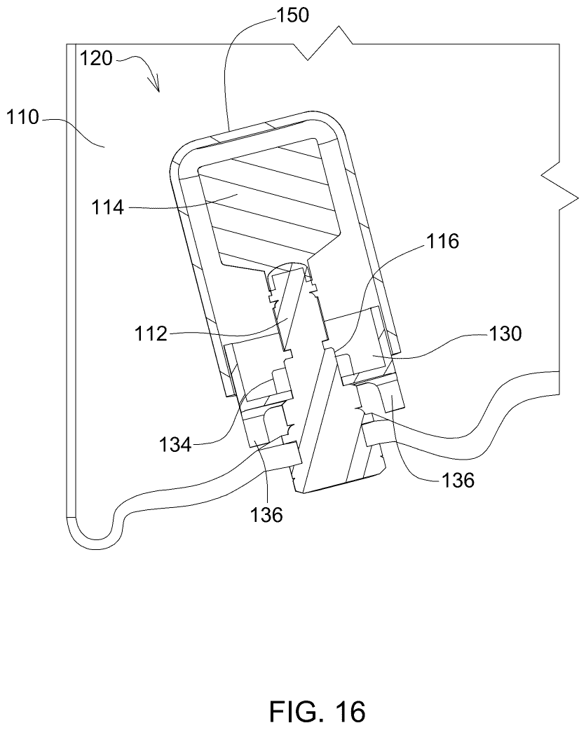

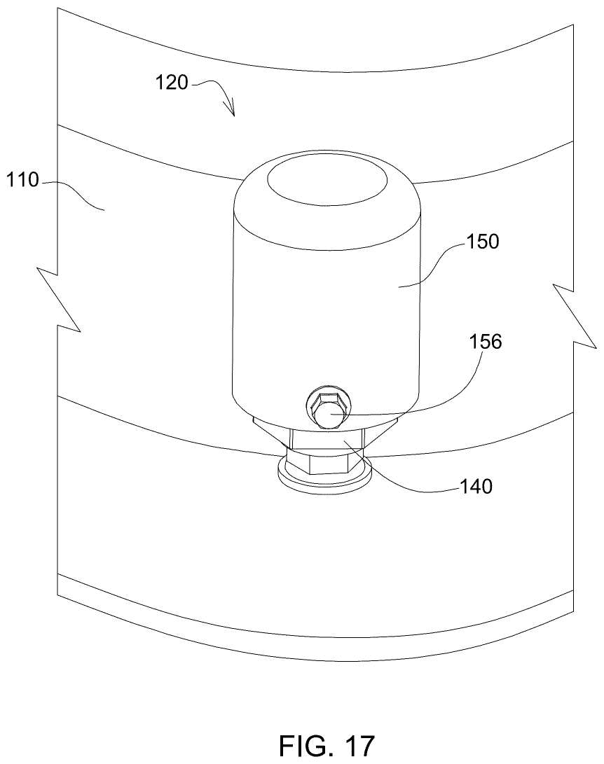

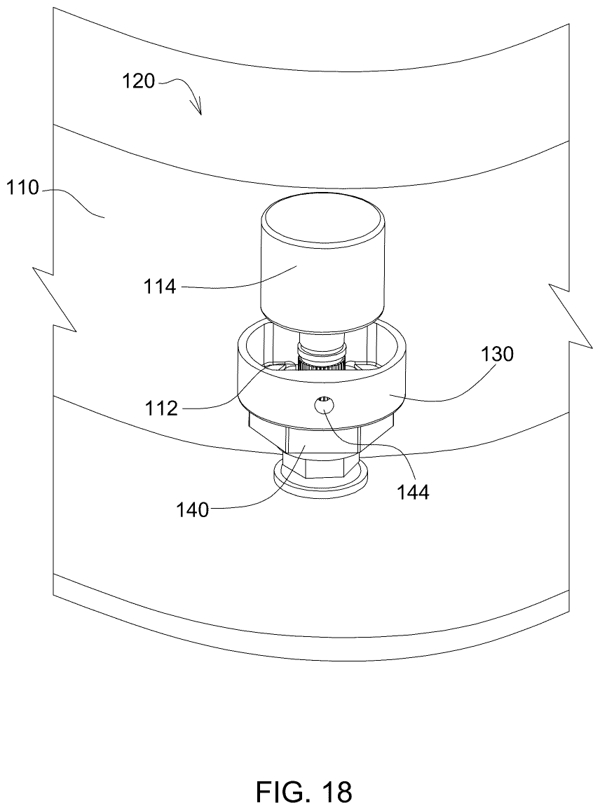

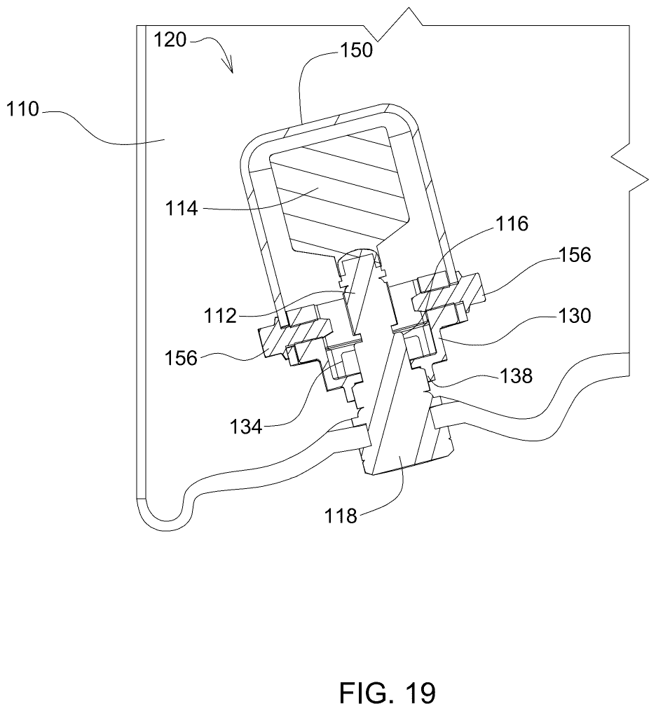

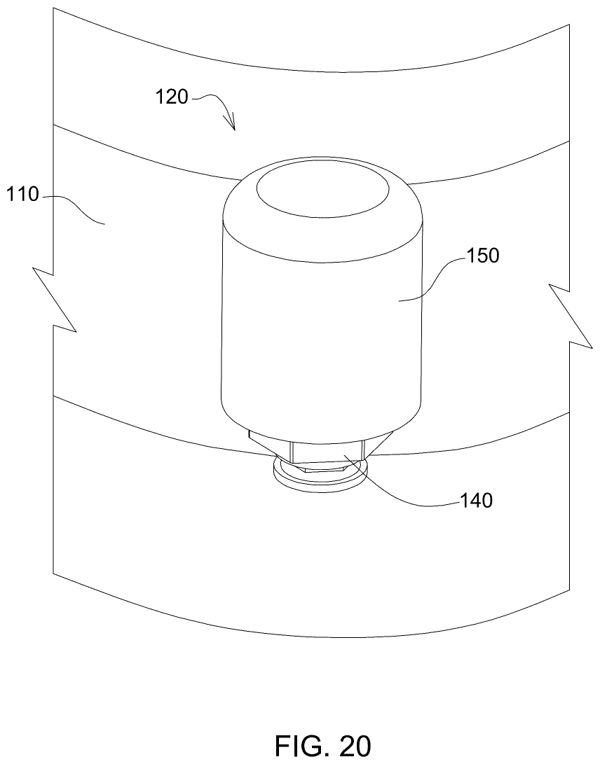

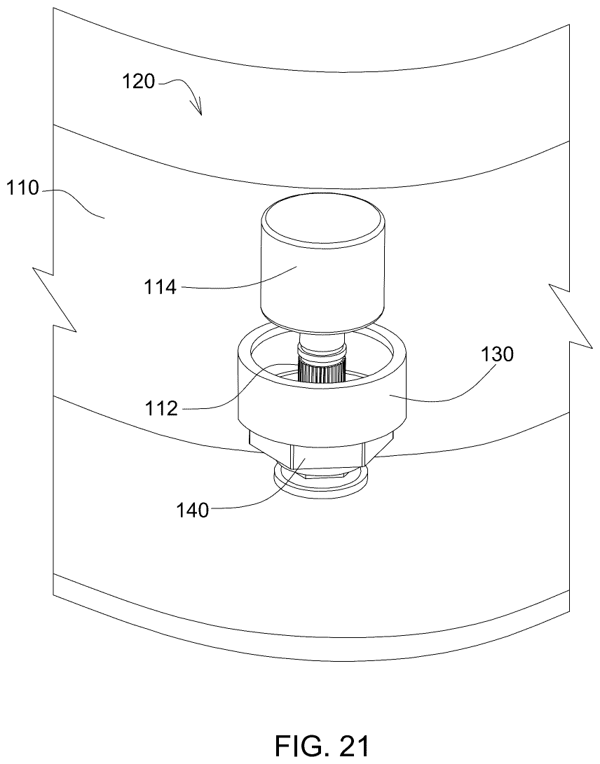

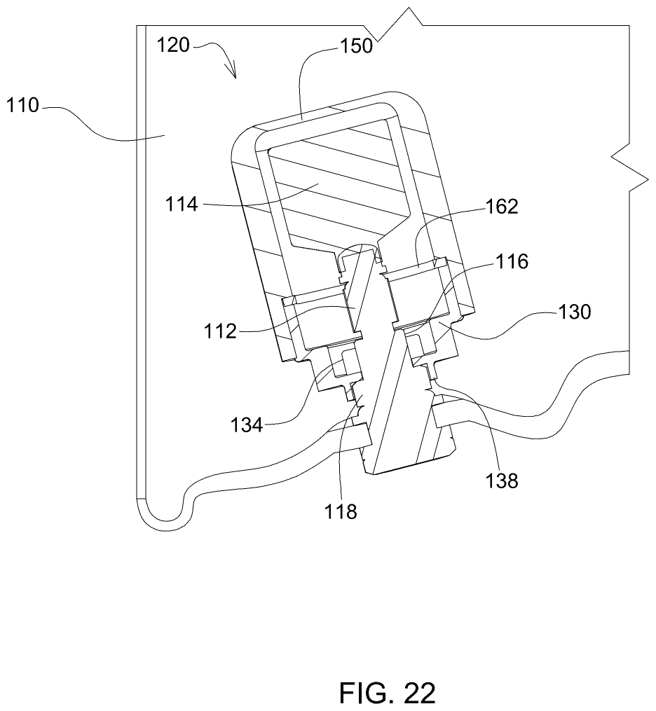

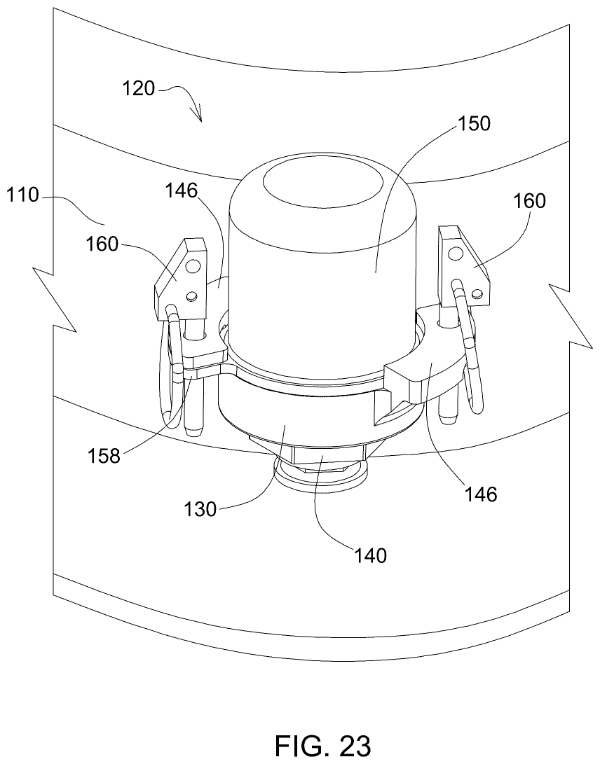

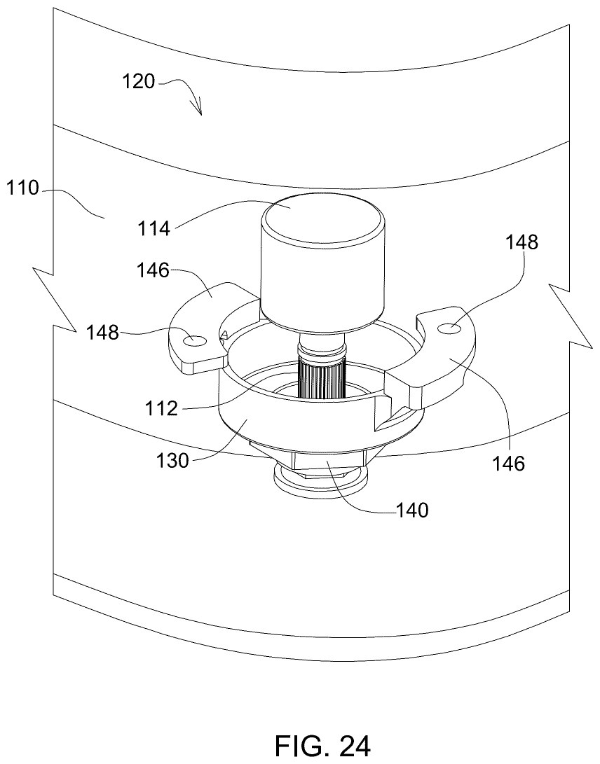

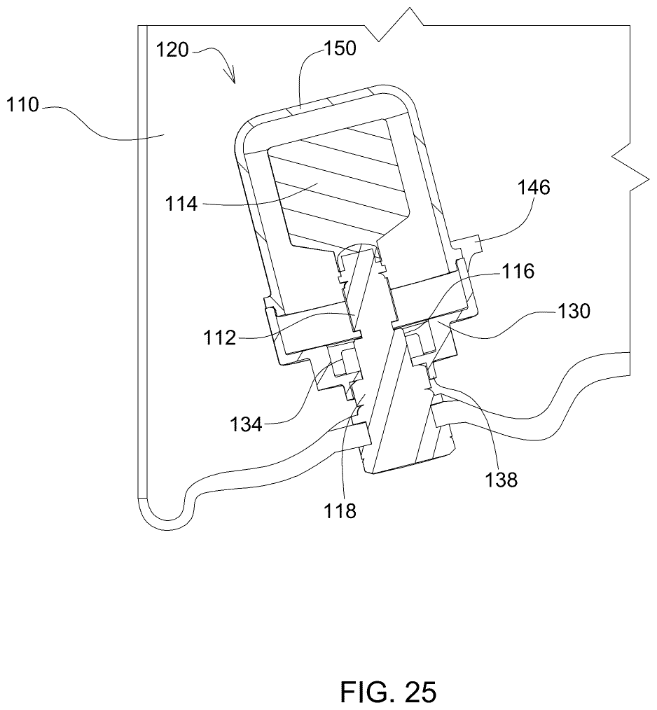

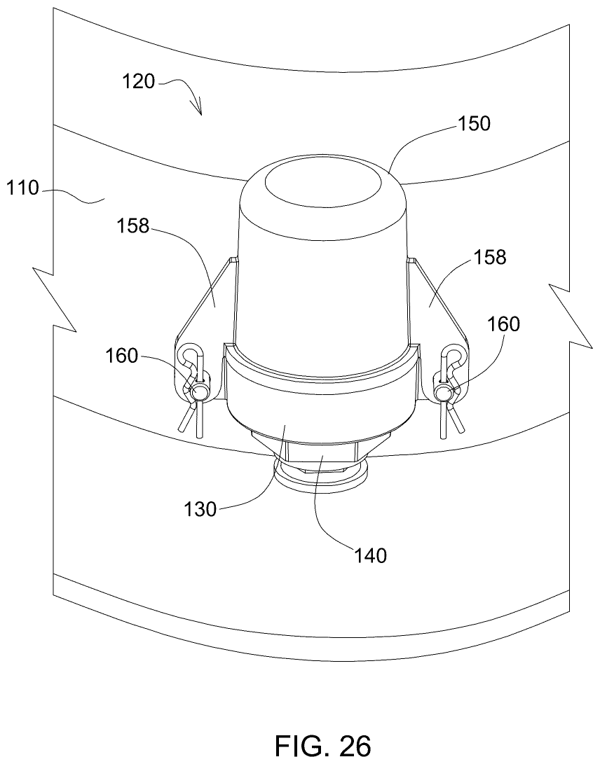

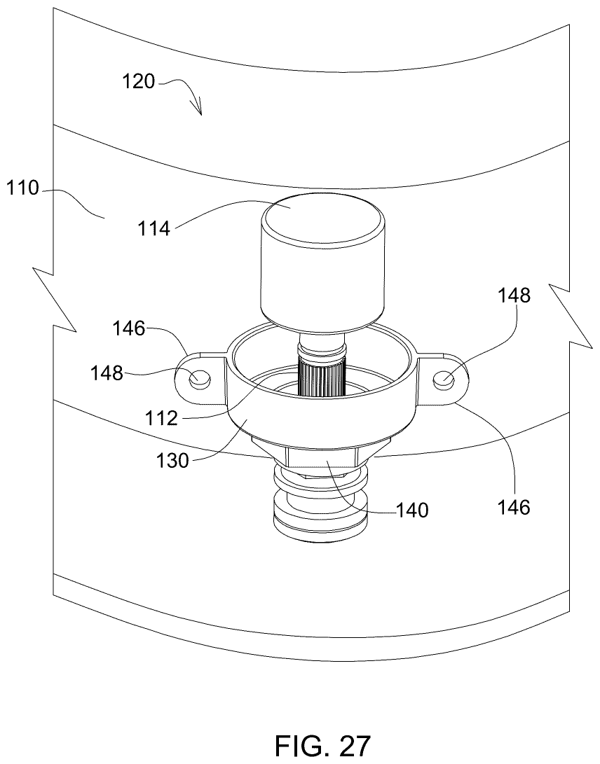

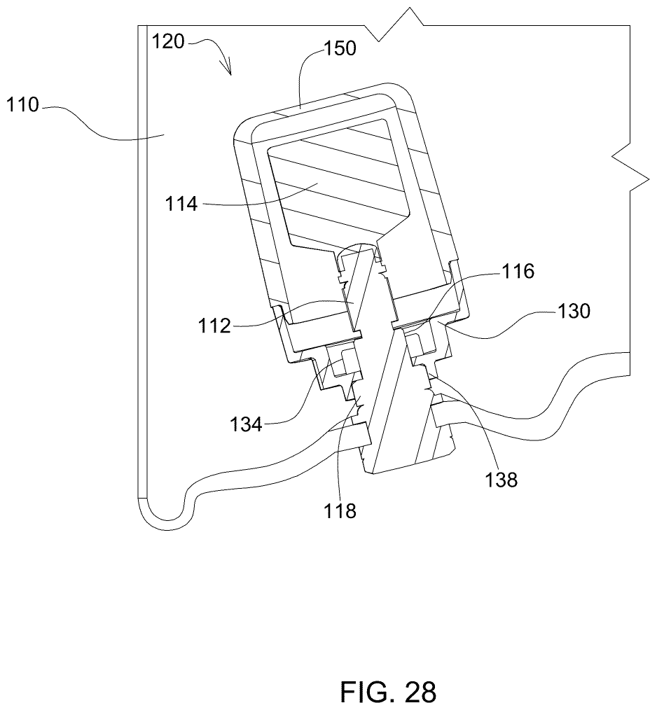

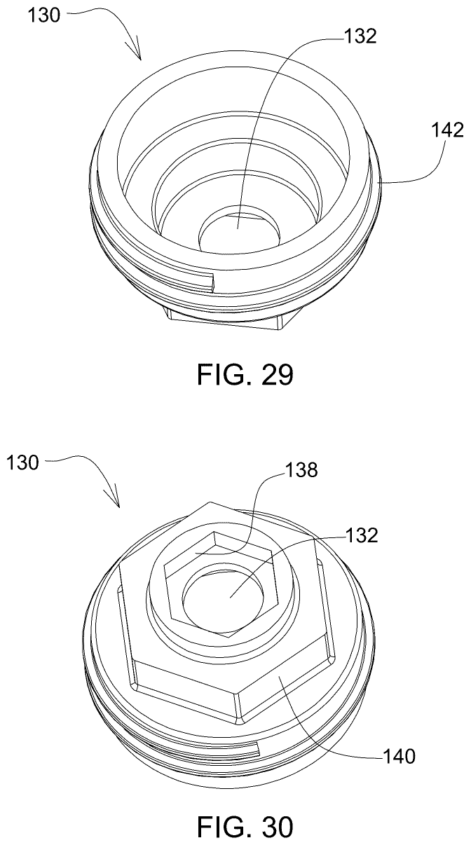

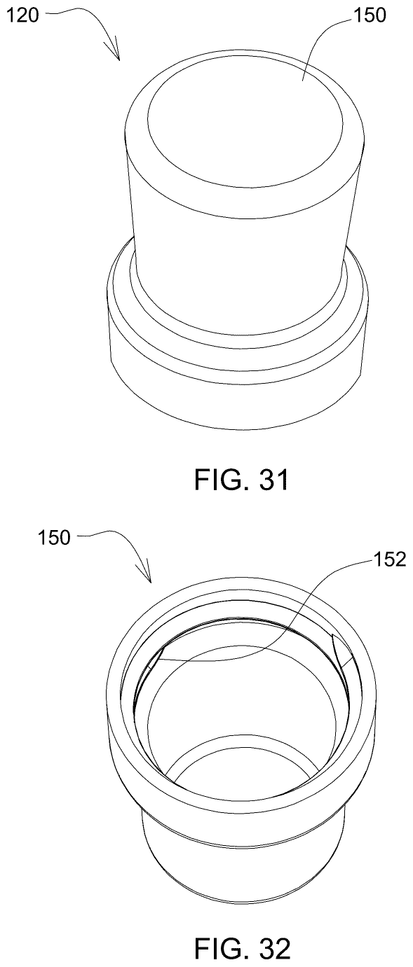

The cap 150 is removably attached to the base 130. When the cap 150 is attached to the base 130, the cap 150 and the base 130 form an enclosure to receive the valve stem 112 and a tire pressure sensor 114 connected to the valve stem 112. The tire pressure sensor 114 can removably attach to the valve stem 112 via screw threads. The cap 150 and base 130 can form a partial enclosure, as shown for example in FIGS. 2 and 3, in which the base 130 has an opening in the side, or as shown for example in FIGS. 5 and 7, in which the cap 150 forms a gap or opening between the cap 150 and the base 130. The cap 150 and base 130 can form a full enclosure, as shown in the several other implementations.

The cap 150 can removably attach or fasten to the base 130 via interacting screw threads. For example, screw threads 152 on the cap 150 can engage with screw threads 142 on the base 130 to removably fasten the cap 150 to the base 130. In another example, buttress threads 152 on the cap 150 engage with buttress threads 142 on the base 130 to removably fasten the cap 150 to the base 130. Various other types of screw threads could be utilized in this arrangement.

In some implementations, the cap 150 can removably attach to the base 130 via a friction fit. In some implementations, the cap 150 can removably attach to the base 130 via flexible ribs 154. In some implementations, the cap 150 can removably attach to the base 130 via a fastener 156 engaging a threaded opening 144 in the base 130. In some implementations, the cap 150 can removably attach to the base 130 via a plurality of fasteners 156 engaging threaded openings 144 in the base 130. In some implementations, the base 130 can include one or more extensions 146. The cap 150 can include one or more extensions 158. One or more fasteners 160 (e.g., a screw, bolt, or pin) connect the one or more extensions 158 of the cap 150 to the one or more extensions 146 of base 130. Each fastener 160 can pass through an opening in the cap 150 and an opening 148 in the base 130. In some implementations, a seal 162 can be positioned between the cap 150 and the base 130 forming a sealed enclosure when the cap 150 is attached to the base 130.

According to some implementations, the valve stem cover 120 can protect the valve stem 112 and the attached tire pressure sensor 114 from the environmental conditions during operation of the work vehicle 100. The valve stem cover 120 can protect the valve stem 112 and the attached tire pressure sensor 114 from objects and debris contacting the valve stem cover 120. The base 130 can be attached to and removed from the valve stem 112 on a variety of different wheels 110. The cap 150 is removable from the base 130 for access to the tire pressure sensor 114 and the valve stem 112 (e.g., to inflate or deflate the tire or to attach, remove, or replace the tire pressure sensor).

Features from the various implementations described herein can be included, combined, and/or replaced with features of the other implementations described herein.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A valve stem cover, comprising:
a base configured to removably attach to the valve stem protruding from a wheel, the base including an opening to receive the valve stem; and
a cap removably attached to the base, the cap and the base forming an enclosure configured to receive the valve stem and a tire pressure sensor connected to the valve stem.

2. The valve stem cover of claim 1, further comprising a fastener configured to removably attach the base to the valve stem, the fastener configured to engage threads of the valve stem.

3. The valve stem cover of claim 1, wherein the base includes an axial protrusion extending toward the wheel to resist rotation of the base.

4. The valve stem cover of claim 1, wherein the base includes an internal bolt head pattern configured to fit over a nut positioned on the valve stem below the base to resist rotation of the base.

5. The valve stem cover of claim 1, wherein the base includes two or more corresponding flat surfaces configured to receive a wrench.

6. The valve stem cover of claim 1, wherein the base includes an external bolt head pattern configured to receive a wrench.

7. The valve stem cover of claim 1, wherein the cap removably fastens to the base via interacting screw threads.

8. The valve stem cover of claim 1, wherein screw threads on the cap engage with screw threads on the base to removably fasten the cap to the base.

9. The valve stem cover of claim 1, wherein buttress threads on the cap engage with buttress threads on the base to removably fasten the cap to the base.

10. The valve stem cover of claim 1, wherein the cap removably attaches to the base via a friction fit.

11. The valve stem cover of claim 1, wherein the cap removably attaches to the base via flexible ribs.

12. The valve stem cover of claim 1, wherein the base includes one or more extensions, the cap includes one or more extensions, and one or more fasteners connect the one or more extensions of the cap to the one or more extensions of base.

13. The valve stem cover of claim 1, wherein the base includes threads around the opening to engage threads of the valve stem.

14. The valve stem cover of claim 1, further comprising a seal positioned between the base and the cap forming a sealed enclosure when the cap is attached to the base.

15. A valve stem cover, comprising:
a base configured to removably attach to the valve stem protruding from a wheel, the base including an opening to receive the valve stem, the base including an internal bolt head pattern configured to fit over a nut positioned on the valve stem below the base to resist rotation of the base, the base including an external bolt head pattern configured to receive a wrench;
a cap removably attached to the base, the cap and the base forming an enclosure configured to receive the valve stem and a tire pressure sensor connected to the valve stem, the cap removably fastened to the base via screw threads; and
a fastener configured to removably attach the base to the valve stem, the fastener configured to engage threads of the valve stem.
